(19) United States
(12) Patent Application Publication
(10) Pub. No.: US 2025/0031886 A1
(43) Pub. Date: Jan. 30, 2025

(54) FLOCKED HANGER CLIP

(71) Applicant: Whitmor, Inc., Southaven, MS (US)

(72) Inventors: James Tabujara, Memphis, TN (US); Sandy A. Felsenthal, Memphis, TN (US)

(21) Appl. No.: 18/225,858

(22) Filed: Jul. 25, 2023

(51) Int. Cl. A47G 25/48; F16B 2/00; F16B 2/22

(52) U.S. Cl. CPC A47G 25/48; F16B 2/005; F16B 2/22

(57) ABSTRACT

A hanger clip assembly includes a body defining a pair of elongate arms each having a pinch grip element disposed at a first end thereof and a gripping surface disposed at a second, opposed end thereof. The pair of elongate arms are joined by an intervening resilient member adapted to bias the pair of elongate arms and associated gripping surfaces towards one another. The body further defines an internal spring clip receiver. The assembly further includes a cooperating spring clip member defined by a pair of elongate spring clip arms joined by an intervening spring clip resilient portion. The spring clip member is dimensioned to be received within an interior of the internal spring clip receiver such that in use the spring clip member assists in biasing each of the pair of elongated arms and associated gripping surfaces towards one another.

### RELATED APPLICATIONS

This application is a utility patent application claiming the benefit of U.S. Provisional Application Ser. No. 63/392,080, filed Jul. 25, 2022, the entire disclosure of which is incorporated herein by reference.

### TECHNICAL FIELD

The presently-disclosed subject matter generally relates to the field of garment display devices. In particular, the presently-disclosed subject matter relates to a hanger clip for securing a garment to a clothes hanger.

### BACKGROUND

It is known in the art, particularly in fields such as retail clothing sales or home closet organization, to affix or clip garments such as trousers, skirts, and others to a clothes hanger by way of a hanger clip rather than placing the garment over the clothes hanger bar. This allows more convenient removal and replacement of the garment on the clothes hanger, for example when a potential buyer wishes to examine and/or try on the garment. Moreover, clipping garments to clothes hangers rather than carrying them over a hanger bar may aid in reducing wrinkling, particularly in crowded store racks or closets.

Certain conventional hanger clips are substantially U- or V-shaped clips, not unlike clothespins of known design in form and function. Such hangers typically include opposed gripping surfaces that are biased towards one another by a resilient portion of the hanger clip, to allow clipping a garment to a clothes hanger. While effective for its intended purpose, a conventional hanger clip may provide insufficient gripping pressure that may allow a clipped garment to slip or separate from the clothes hanger. Hanger clips having a spring element to enhance the gripping strength are often complex in design.

The present disclosure solves this problem by providing a flocked suit hanger clip that provides a suitably strong grip for retaining garments on a clothes hanger, while requiring fewer parts and less material for fabrication.

### SUMMARY

In accordance with the purposes and benefits described herein, this disclosure describes embodiments of an inventive flocked hanger clip for use in secure retention of garments on a hanger bar in retail, home, and other settings. Advantageously, the described flock hanger clips provide secure garment retention, but are less complex, have fewer parts, and are correspondingly simpler and less costly to manufacture. The described hanger clips further advantageously require less material and less assembly than conventional hanger clips.

In one aspect, the present document discloses a hanger clip assembly comprising a body. The body defines a pair of elongate arms each having a pinch grip element disposed at a first end thereof and a gripping surface disposed at a second, opposed end thereof. The gripping surfaces may optionally include a toothed or ridged gripping surface. The pair of elongate arms are joined by an intervening resilient member adapted to bias the pair of elongate arms and associated gripping surfaces towards one another. The hanger clip assembly body further defines an internal spring clip receiver.

The hanger clip assembly further includes a cooperating spring clip member dimensioned to be received within an interior of the internal spring clip receiver. The spring clip member, when positioned in the internal spring clip receiver interior, is adapted to bias each of the pair of elongated arms and associated gripping surfaces towards one another. The spring clip member may be defined by a pair of elongate spring clip arms joined by an intervening spring clip resilient portion.

In a possible embodiment, each of the pair of elongate spring clip arms ends in a flanged end. In this embodiment, the internal spring clip receiver includes a pair of cooperating receiver elements adapted and dimensioned to securely receive each of the pair of spring clip arm flanged ends therein. In other potential embodiments, the spring clip receiver may be adapted to retain the spring clip member by one or more of an interference fit, a friction fit, a snap-fit, and one or more retaining clips. The hanger clip assembly may include one or more of these features in potential alternative embodiments.

In other possible embodiments, the body further defines a hanger bar receiver adapted to receive a portion of a clothes hanger bar. In one potential embodiment, the hanger bar receiver includes a pair of cooperating clips adapted to engage the portion of the clothes hanger bar.

In yet another possible embodiment, a hanger clip assembly is described comprising a body defining a pair of elongate arms each having a pinch grip element disposed at a first end thereof and a gripping surface disposed at a second, opposed end thereof. The pair of elongate arms are joined by an intervening resilient member adapted to bias the pair of elongate arms and associated gripping surfaces towards one another. The body further defines an internal spring receiver. A cooperating spring clip member defined by a pair of elongate spring clip arms joined by an intervening spring clip resilient portion is also provided. The spring clip member is dimensioned to be received within an interior of the internal spring clip receiver and is further adapted, when positioned in the internal spring clip receiver interior, to bias each of the pair of elongated arms and associated gripping surfaces towards one another. Each gripping surface optionally includes a toothed or ridged surface. The spring clip member may be defined by a pair of elongate spring clip arms joined by an intervening spring clip resilient portion.

As before, in a possible embodiment each of the pair of elongate spring clip arms ends in a flanged end. In this embodiment, the internal spring clip receiver includes a pair of cooperating receiver elements adapted and dimensioned to securely receive each of the pair of spring clip arm flanged ends therein. In other potential embodiments, the spring clip receiver may be adapted to retain the spring clip member by one or more of an interference fit, a friction fit, a snap-fit, and one or more retaining clips. The hanger clip assembly may include one or more of these features in potential alternative embodiments.

As before, in other possible embodiments the body further defines a hanger bar receiver adapted to receive a portion of a clothes hanger bar. In one potential embodiment, the hanger bar receiver includes a pair of cooperating clips adapted to engage the portion of the clothes hanger bar.

In the following description, there are shown and described several embodiments of the disclosed flocked hanger clip. As it should be realized, the disclosed device is capable of other, different embodiments and their several details are capable of modification in various, obvious aspects all without departing from the device as set forth and described in the following claims. Accordingly, the drawings and descriptions should be regarded as illustrative in nature and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are used, and the accompanying drawings of which:

FIG. 1 is a front perspective view of an embodiment of a hanger clip assembly according to the present disclosure.

FIG. 2 is a rear perspective view of the hanger clip assembly shown in FIG. 1.

FIG. 3 is a partially exploded view of the hanger clip assembly shown in FIG. 2.

FIG. 4 is a front perspective view of a spring clip member for use in the hanger clip assembly of the present disclosure.

FIG. 5 is a front view of a spring clip member for use in the hanger clip assembly of the present disclosure.

FIG. 6 is a side view of a spring clip member for use in the hanger clip assembly of the present disclosure.

FIG. 7 is a top view of a spring clip member for use in the hanger clip assembly of the present disclosure.

FIG. 8 is a rear perspective view of an alternative embodiment of an outer housing element for the hanger clip of the present disclosure.

FIG. 9 is a front perspective view of the outer housing element of FIG. 8.

FIG. 10 is a rear view of outer housing element of FIG. 8.

FIG. 11 is a front view of the outer housing element of FIG. 8.

FIG. 12 is a side view of the outer housing element of FIG. 8.

FIG. 13 is a top view of the outer housing element of FIG. 8.

FIG. 14 is a bottom view of the outer housing element of FIG. 8.

FIG. 15 is a partially exploded front perspective view of the hanger clip assembly of FIG. 8.

FIG. 16 is a rear perspective view of the hanger clip assembly of FIG. 8.

FIG. 17 illustrates the hanger clip assembly of FIG. 8 in use.

### DETAILED DESCRIPTION

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

It will be appreciated that for simplicity and clarity of illustration, where appropriate, reference numerals are repeated among the various figures to indicate corresponding, identical, or analogous features. Numerous specific details are set forth in order to provide a thorough understanding of the embodiments described herein. However, those of ordinary skill in the art will understand that the embodiments described herein can be practiced without these specific details. In other instances, methods, procedures, and components have not been described in detail so as not to obscure the related relevant feature being described. Still more, different features of different embodiments may be combined, and such combinations are expressly contemplated as part of the invention. The drawings are not necessarily to scale and the proportions of certain parts may be exaggerated to better illustrate details and features. The description is not to be considered as limiting the scope of the embodiments described herein.

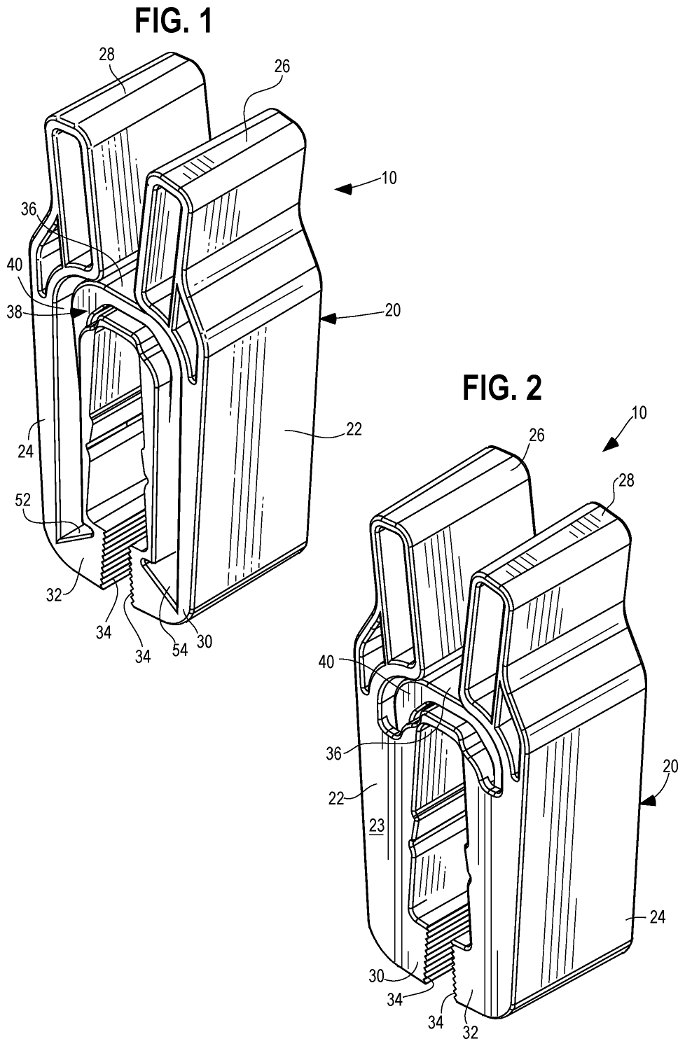

In one embodiment, a flocked suit hanger clip assembly is provided that is adapted for clipping a garment to a clothes hanger. With reference to FIG. 1, a flocked suit hanger clip assembly 10 includes a housing body 20 defined by first and second arms 22, 24. Each of first and second arms 22, 24 respectively include a pinch grip portion 26, 28 at a first end and a gripping surface 30, 32 at an opposed end thereof. Gripping surfaces 30, 32 may be smooth, or as depicted may include a ridged or toothed surface 34 to improve grip on a garment G (not shown in this view). The housing body 20 further includes an intervening portion 36 which joins first and second arms 22, 24. Intervening portion 36 may be sufficiently resilient to urge or bias gripping surfaces 30, 32 towards one another.

A portion of the housing body 20 defines an interior recess or receiver 38 (see FIG. 1), dimensioned to receive a spring clip member 40 therein. Portions of first and second arms 22, 24 may define rear walls 23, 25 of the interior recess or receiver 38 to assist in retaining spring clip member 40 in place. Additional retention mechanisms may be provide to retain spring clip member 40 in place within the interior recess or receiver 38. As non-limiting examples, contemplated retention mechanisms including a friction fit engagement of spring clip member 40 and interior recess or receiver 38, an interference fit engagement of spring clip member 40 and interior recess or receiver 38, a snap-fit engagement of spring clip member 40 and interior recess or receiver 38, snap-fit or other retaining clips (see FIG. 15) and others. Further, it is contemplated to provide combinations of these and other retention mechanisms to keep spring clip member 40 in place.

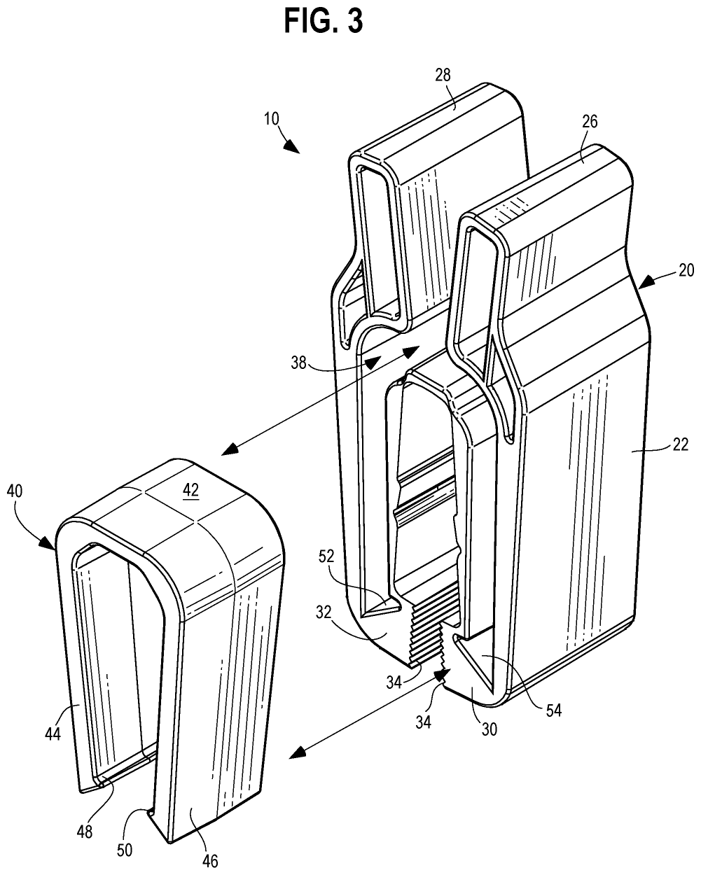

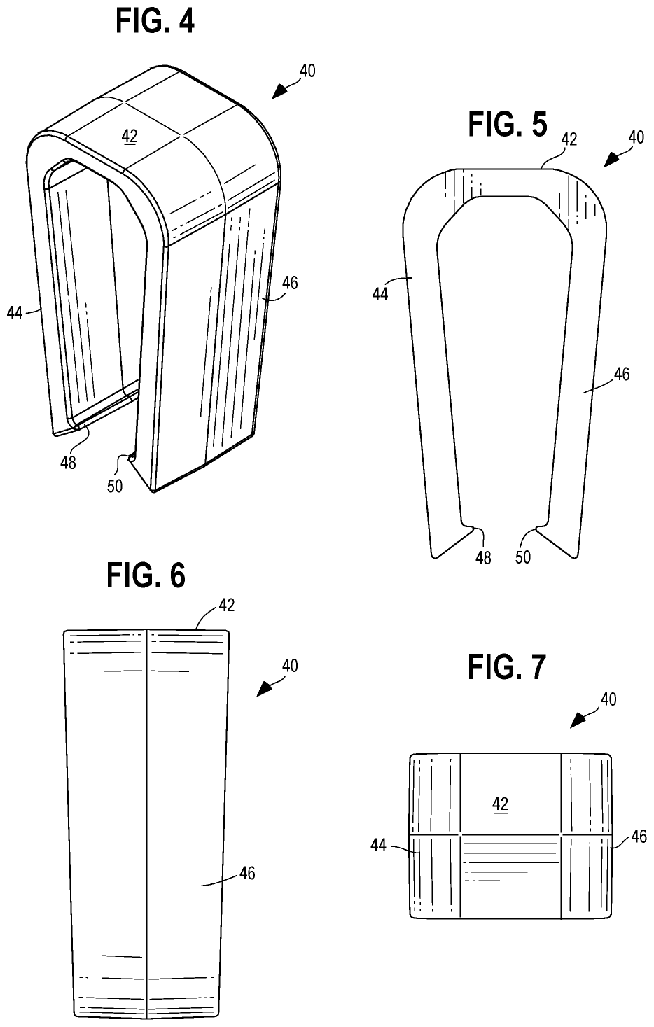

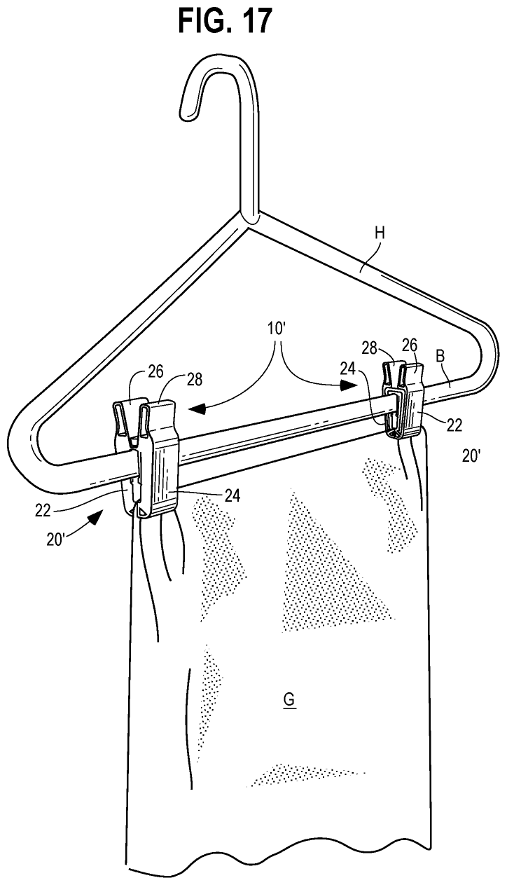

As shown in FIG. 3 (see also FIGS. 4-7), spring clip member 40 includes an intervening resilient portion 42 from which first and second arms 44, 46 depend. First and second arms 44, 46 optionally may each terminate in flanged ends 48, 50. Likewise, the interior recess or receiver 38 may include at a bottom portion thereof cooperating receiver elements 52, 54 dimensioned to snugly receive flanged ends 48, 50 therein for a more secure retention of spring clip member 40/first and second arms 44, 46 during a biasing operation. As will be appreciated, the engagement of spring clip member first and second arms 44, 46 and corresponding flanged ends 48, 50 and interior recess or receiver cooperating receiver elements 52, 54 causes spring clip member first and second arms 44, 46 to be biased away from one another when a user biases pinch grip portions 26, 28 towards one another. Of course, this also biases first and second arms 22, 24/gripping surfaces 30,32 away from one another to separate gripping surfaces 30, 32 a spaced distance from one another, sufficient to allow a user to capture a portion of a garment G (see FIG. 17) between gripping surfaces 30, 32 or alternatively to release the garment G portion so captured.

In use, the housing body 20 may be configured to concurrently grip a garment G as described above and also to hang over a hanger bar B of a clothes hanger H (see FIG. 17) whereby the hanger bar carries the housing body 20 and the garment G. As will be appreciated, when positioned within recess or receiver 38, spring clip member 40 assists housing body 20 resilient intervening portion 36 in urging gripping surfaces 30, 32 towards one another to more securely grasp or clamp a portion of a garment G (see FIG. 17) placed therebetween. To release the garment G, as described above a user need only bias pinch grip portions 26, 28 towards one another to overcome the biasing force imposed by resilient intervening portion 36/spring clip member 40, thus separating gripping surfaces 30, 32 from one another.

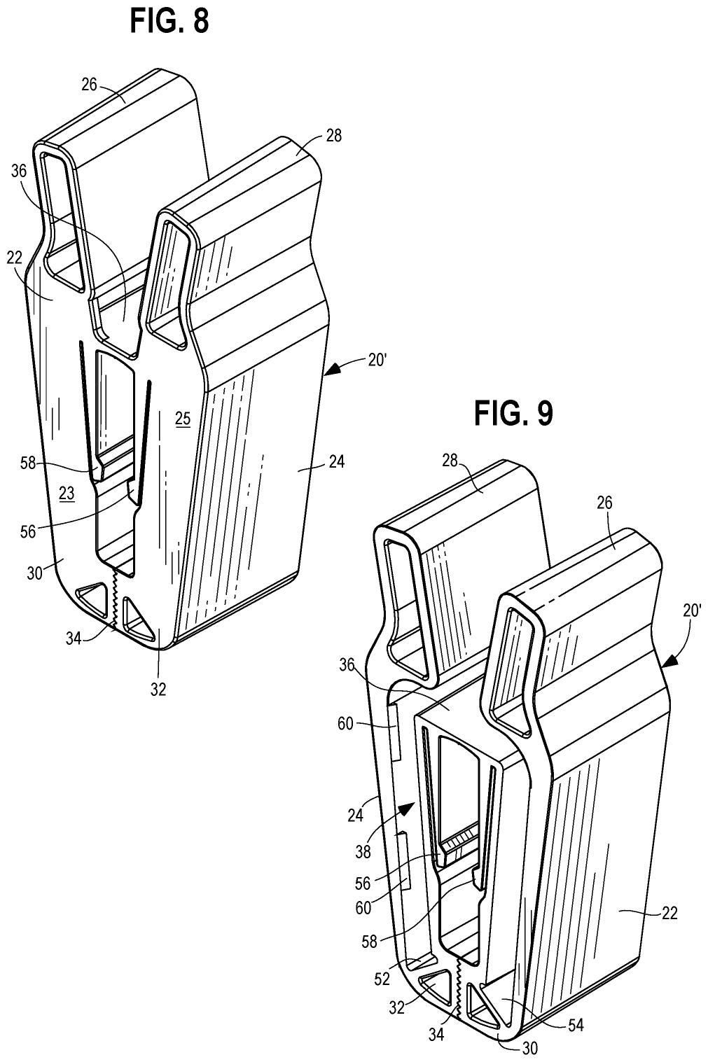

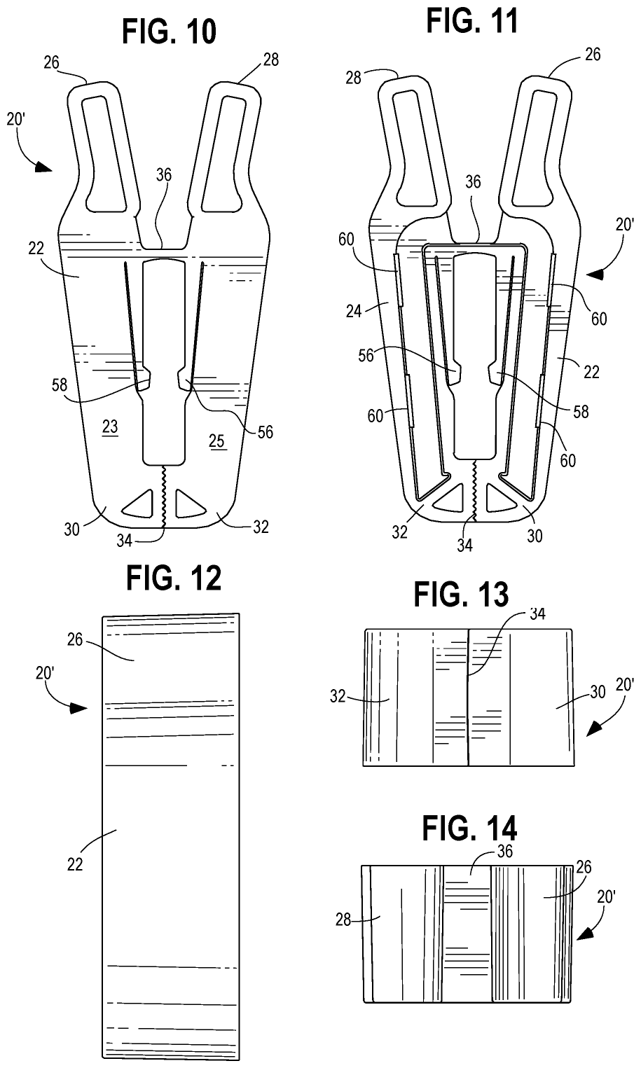

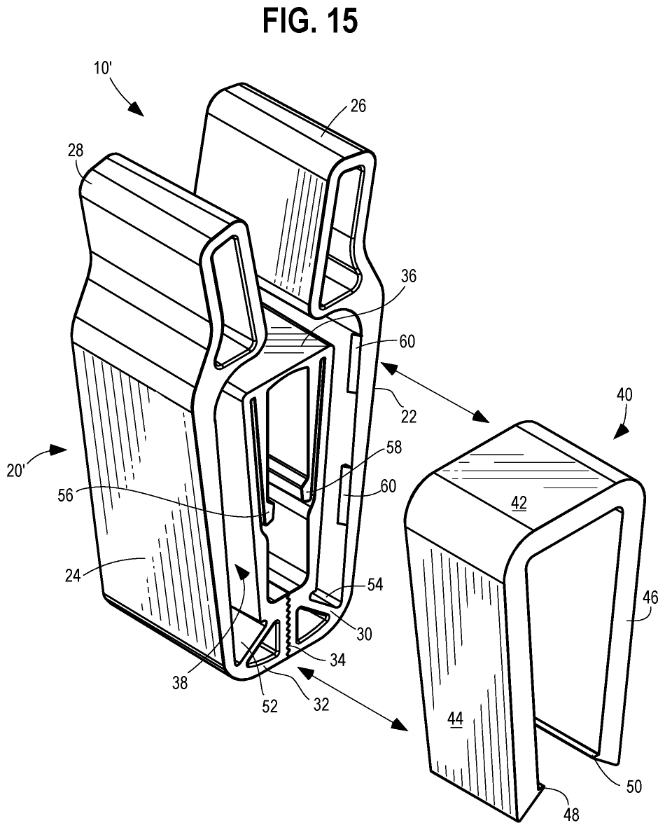

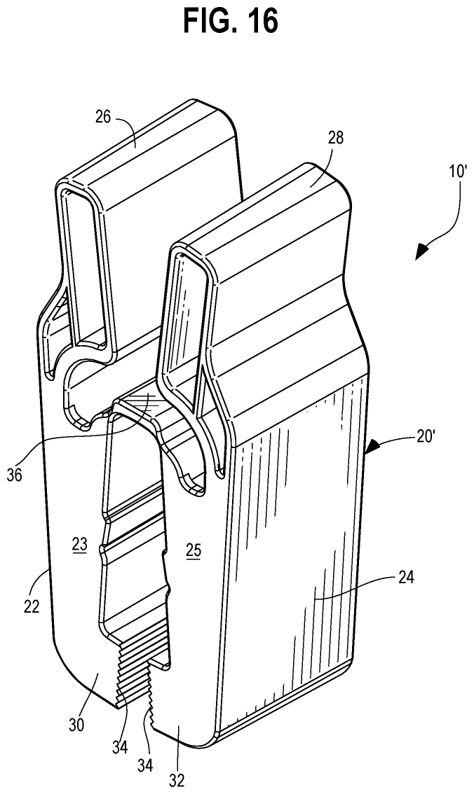

In an alternative embodiment of the flocked suit hanger clip assembly 10′ (see FIGS. 8-14), the housing body 20 may include resilient hanger bar clips 56, 58 which engage a portion of the hanger bar B to provide a more secure engagement and to reduce or prevent lateral movement of the garment G hanger clip 10. The depicted embodiment of the housing body 20 includes one or more retaining clips 60 disposed at an edge of recess or receiver 38, which as discussed supra provide enhanced retention of spring clip member 40 (not shown in this view) by a snap-fit engagement. As shown in FIGS. 15-16, spring clip member 40 is urged into position in an interior of recess or receiver 38 and snapped into place whereby retaining clips 60 engage and secure the spring clip member 40.

Thus, as shown in FIG. 17, a convenient, effective hanger clip 10, 10′ is provided for securing a garment G to a hanger H. Advantageously, the disclosed hanger clip 10, 10′ is less complex, has fewer parts, and is therefore simpler to manufacture, requiring less material and less assembly than conventional hanger clips of this type. However, by use of a hanger clip including a body resilient portion in combination with a spring clip member, a stronger grip is provided compared to conventional hanger clips for grasping and holding garments in place on a clothes hanger bar.

Although other methods, devices, and materials similar or equivalent to those described herein can be used in the practice or testing of the presently-disclosed subject matter, representative methods, devices, and materials are described herein.

Following long-standing patent law convention, the terms “a”, “an”, and “the” refer to “one or more” when used in this application, including the claims. As used herein, “optional” or “optionally” means that the subsequently described event or circumstance does or does not occur and that the description includes instances where said event or circumstance occurs and instances where it does not.

Any publications, patents, and patent applications mentioned in this specification are herein incorporated by reference to the same extent as if each individual publication, patent, or patent application was specifically and individually indicated to be incorporated by reference,

It will be understood that various details of the presently disclosed subject matter can be changed without departing from the scope of the subject matter disclosed herein. Furthermore, the foregoing description is for the purpose of illustration only, and not for the purpose of limitation.

What is claimed:

1. A hanger clip assembly, comprising:
a body defining:
a pair of elongate arms each having a pinch grip element disposed at a first end thereof and a gripping surface disposed at a second, opposed end thereof, wherein the pair of elongate arms are joined by an intervening resilient member adapted to bias the pair of elongate arms and associated gripping surfaces towards one another; and
an internal spring clip receiver.

2. The hanger clip assembly of claim 1, wherein the gripping surface includes a toothed or ridged surface.

3. The hanger clip assembly of claim 1, further including a cooperating spring clip member dimensioned to be received within an interior of the internal spring clip receiver;
wherein the spring clip member, when positioned in the internal spring clip receiver interior, is adapted to bias each of the pair of elongated arms and associated gripping surfaces towards one another.

4. The hanger clip assembly of claim 1, wherein the spring clip member is defined by a pair of elongate spring clip arms joined by an intervening spring clip resilient portion.

5. The hanger clip assembly of claim 4, wherein each of the pair of elongate spring clip arms ends in a flanged end.

6. The hanger clip assembly of claim 5, wherein the internal spring clip receiver includes a pair of cooperating receiver elements adapted and dimensioned to securely receive each of the pair of spring clip arm flanged ends therein.

7. The hanger clip assembly of claim 1, wherein the body further defines a hanger bar receiver adapted to receive a portion of a clothes hanger bar.

8. The hanger clip assembly of claim 7, wherein the hanger bar receiver includes a pair of cooperating clips adapted to engage the portion of the clothes hanger bar.

9. The hanger clip assembly of claim 3, wherein the spring clip receiver is adapted to retain the spring clip member by one or more of an interference fit, a friction fit, a snap-fit, and one or more retaining clips.

10. A hanger clip assembly, comprising:
a body defining:
a pair of elongate arms each having a pinch grip element disposed at a first end thereof and a gripping surface disposed at a second, opposed end thereof, wherein the pair of elongate arms are joined by an intervening resilient member adapted to bias the pair of elongate arms and associated gripping surfaces towards one another; and
an internal spring receiver; and
a cooperating spring clip member defined by a pair of elongate spring clip arms joined by an intervening spring clip resilient portion;
wherein the spring clip member is dimensioned to be received within an interior of the internal spring clip receiver and is further adapted, when positioned in the internal spring clip receiver interior, to bias each of the pair of elongated arms and associated gripping surfaces towards one another.

11. The hanger clip assembly of claim 10, wherein the gripping surface includes a toothed or ridged surface.

12. The hanger clip assembly of claim 10, wherein the spring clip member is defined by a pair of elongate spring clip arms joined by an intervening spring clip resilient portion.

13. The hanger clip assembly of claim 10, wherein the internal spring clip receiver is adapted to retain the spring clip member by one or more of an interference fit, a friction fit, a snap fit, and one or more retaining clips.

14. The hanger clip assembly of claim 10, wherein each of the pair of elongate spring clip arms ends in a flanged end.

15. The hanger clip assembly of claim 14, wherein the internal spring clip receiver includes a pair of cooperating receiver elements adapted and dimensioned to securely receive each of the pair of spring clip arm flanged ends therein.

16. The hanger clip assembly of claim 10, wherein the body further defines a hanger bar receiver adapted to receive a portion of a clothes hanger bar.

17. The hanger clip assembly of claim 16, wherein the hanger bar receiver includes a pair of cooperating clips adapted to engage the portion of the clothes hanger bar.
